(19) United States
(12) Patent Application Publication
(10) Pub. No.: US 2015/0140935 A1
(43) Pub. Date: May 21, 2015

(54) BLUETOOTH SWIVEL BRACKET

(71) Applicant: CHIH-JUH WONG, New Taipei City (TW)

(72) Inventor: CHIH-JUH WONG, New Taipei City (TW)

(21) Appl. No.: 14/082,206

(22) Filed: Nov. 18, 2013

(51) Int. Cl. H04M 1/04; H04W 4/00

(52) U.S. Cl. CPC H04M 1/04; H04W 4/008
USPC 455/41.3

(57) ABSTRACT

A bluetooth swivel bracket is used to hold a handheld electronic devices and to play audio information of the handheld electronic device and contains a body, a universal rotating head, and a bluetooth mechanism disposed in the body. An upper side of the body is rotatably connected with the universal rotating head, and the bluetooth mechanism includes a bluetooth module for receiving the audio information of the handheld electronic device, a speaker, and a power supply component for supplying power. The power supply component and the speaker are electrically connected with the bluetooth module, and the speaker is provided to play the audio information of the handheld electronic device.

### FIELD OF THE INVENTION

The present invention relates to a bluetooth swivel bracket which can change a handheld electronic device to any desired position and angle randomly.

### BACKGROUND OF THE INVENTION

A conventional magnetic sucker is served to position a cellular phone, but it only has a support point to support an end portion of the cellular phone, thus fixing the cellular phone insecurely.

Another conventional phone holder is applied to position the cellular phone at a fixed angle without being adjusted to desired position and angle.

Furthermore, this conventional phone holder cannot adjust sound volume and tone of the cellular phone, and when amplifying the sound volume of the cellular phone, a power of the cellular phone consumes quickly.

The present invention has arisen to mitigate and/or obviate the afore-described disadvantages.

### SUMMARY OF THE INVENTION

The primary object of the present invention is to provide a bluetooth swivel bracket which is capable of overcoming the shortcomings of the conventional toilet.

To obtain the above objectives, a bluetooth swivel bracket provided by the present invention is used to hold a handheld electronic device and to play audio information of the handheld electronic device and contains: a body, a universal rotating head, and a bluetooth mechanism disposed in the body.

An upper side of the body is rotatably connected with the universal rotating head, the bluetooth mechanism includes a bluetooth module for receiving the audio information of the handheld electronic device, a speaker, and a power supply component for supplying power.

The power supply component and the speaker are electrically connected with the bluetooth module, and the speaker is provided to play the audio information of the handheld electronic device.

Preferably, the bluetooth mechanism includes a receiver electrically coupled with the bluetooth module and applied to receive outside sounds and to transmit the outside sounds into the handheld electronic device.

Preferably, the bluetooth mechanism also includes at least one volume control key electrically connected with the speaker.

Preferably, the bluetooth swivel bracket further contains a sucking mechanism, and the sucking mechanism includes a sucker mounted on a lower side of the body.

Preferably, the sucking mechanism also includes a resilient pulling piece rotatably joined with the body, a first side of the resilient pulling piece inserts into the body and is connected with the sucker, and a second side of the resilient pulling piece extends out of the body.

Preferably, the body is bent.

Preferably, the body includes a plurality of sound guiding holes defined thereon and corresponding to the speaker.

Preferably, the upper side of the body is spherical and has a rotary ball mounted thereon, and the universal rotating head includes a spherical cavity defined therein so as to receive the rotary ball.

Preferably, the universal rotating head also includes at least one retainer extending outwardly therefrom, and the handheld electronic device includes at least one locking slot defined on a back surface thereof so as to engage with and disengage from the at least one retainer.

Preferably, the bluetooth swivel bracket further includes a protective case for retaining with the handheld electronic device.

Thereby, the bluetooth swivel bracket of the present invention has the following advantages:

1. The bluetooth swivel bracket 100 can change the handheld electronic device to any desired position and angle randomly, thus enhancing use comfort and convenience.

2. The bluetooth swivel bracket 100 comprises the bluetooth mechanism, and the bluetooth mechanism has the speaker 16 so as to play the audio information of the handheld electronic device directly, such that the user can adjust sound volume and tone in different conditions. In addition, a power consumption of the handheld electronic device for playing the audio information is saved, and a standby time of the handheld electronic device is prolonged.

### BRIEF DESCRIPTION OF THE DRAWINGS

FIG. 1 is a perspective view showing the assembly of a bluetooth swivel bracket according to a preferred embodiment of the present invention.

FIG. 2 is another perspective view showing the assembly of the bluetooth swivel bracket according to the preferred embodiment of the present invention.

FIG. 3 is a perspective view showing the operation of the bluetooth swivel bracket according to the preferred embodiment of the present invention.

FIG. 4 is another perspective view showing the operation of the bluetooth swivel bracket according to the preferred embodiment of the present invention.

FIG. 5 is still another perspective view showing the operation of the bluetooth swivel bracket according to the preferred embodiment of the present invention.

FIG. 6 is a perspective view showing a protective case being connected with the bluetooth swivel bracket according to the preferred embodiment of the present invention.

FIG. 7 is a perspective view showing the operation of the protective case according to the preferred embodiment of the present invention.

FIG. 8 is a perspective view showing another protective case being connected with the bluetooth swivel bracket according to the preferred embodiment of the present invention.

FIG. 9 is also another perspective view showing another protective case being connected with the bluetooth swivel bracket according to the preferred embodiment of the present invention.

### DETAILED DESCRIPTION OF THE PREFERRED EMBODIMENTS

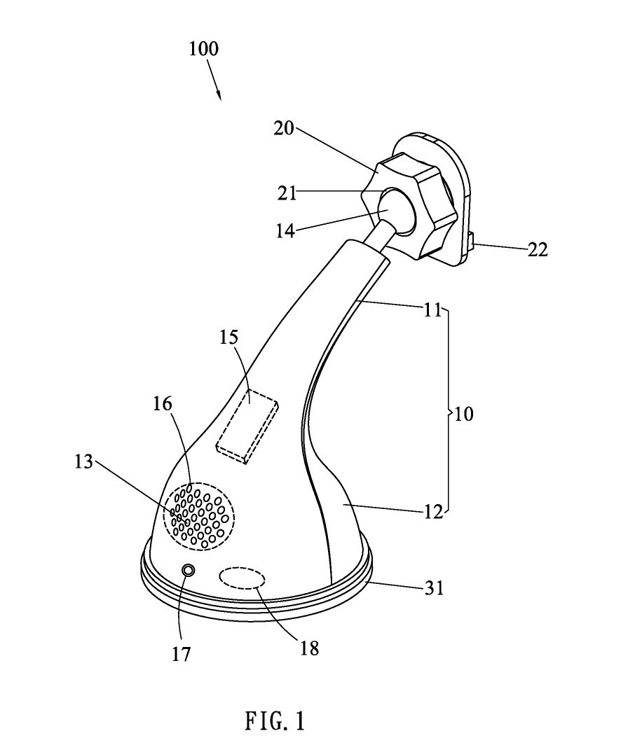

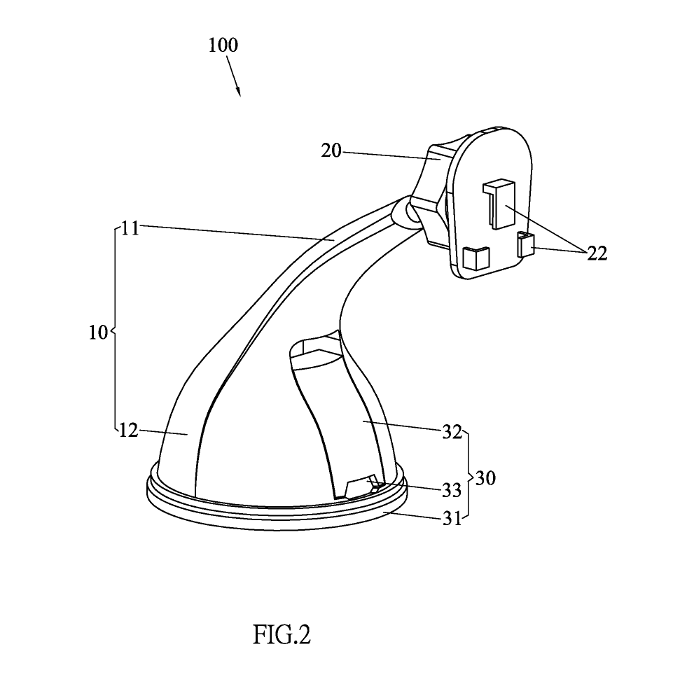

Referring further to FIGS. 1 and 2, a bluetooth swivel bracket 100 according to a first embodiment of the present invention comprises a body 10, a universal rotating head 20, and a bluetooth mechanism disposed in the body 10. An upper side 11 of the body 10 is rotatably connected with the universal rotating head 20, and the universal rotating head 20 is used to hold a handheld electronic device (not shown). The bluetooth mechanism includes a bluetooth module 15 for receiving audio information of the handheld electronic device, a speaker 16, and a power supply component 17 for supplying power. The power supply component 17 and the speaker 16 are electrically connected with the bluetooth module 15, and the speaker 16 is provided to play the audio information of the handheld electronic device.

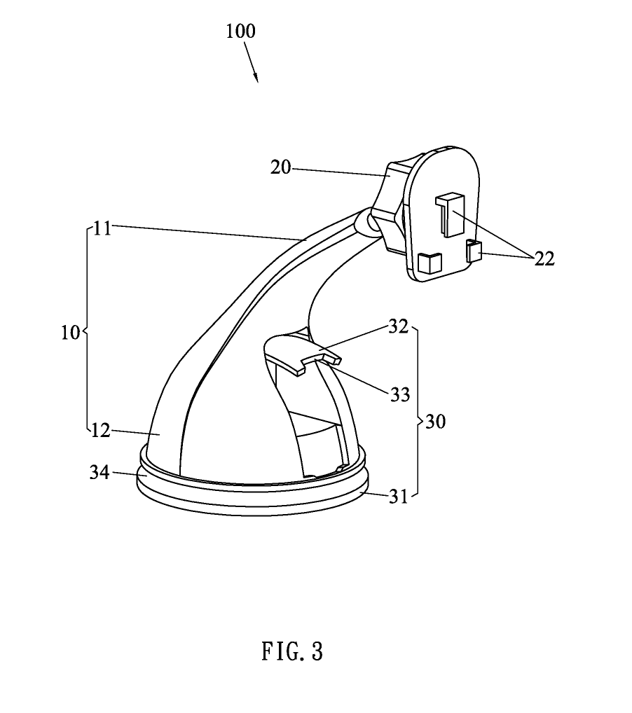

Referring to FIGS. 3-9, the bluetooth swivel bracket 100 comprises:

The bluetooth mechanism includes a receiver 18 electrically coupled with the bluetooth module 15 and applied to receive outside sounds and to transmit the outside sounds into the handheld electronic device. When the bluetooth mechanism matches with a cellular phone, a user can talk the cellular phone by ways of the receiver 18 without holding the cellular phone, thus taking the cellular phone during driving a car conveniently and safely.

The bluetooth mechanism also includes at least one volume control key (not shown) electrically connected with the speaker 16 so as to adjust sound volume based on using requirement.

The body 10 includes a plurality of sound guiding holes 13 defined thereon and corresponding to the speaker 16 so as to transmit sounds made from the speaker 16. In addition, the outside sounds can be transmitted into the receiver 18 of the body 10 via the plurality of sound guiding holes 13, such that sound tone and sound volume are clearly transmitted into the receiver 18.

As shown in FIGS. 3-5, the bluetooth swivel bracket 100 further comprises a sucking mechanism 30, and the sucking mechanism 30 includes a sucker 31 mounted on a lower side 12 of the body 10 so as to position the bluetooth swivel bracket 100 and the handheld electronic device securely.

The sucking mechanism 30 also includes a resilient pulling piece 32 rotatably joined with the body 10, wherein a first side of the resilient pulling piece 32 inserts into the body 10 and is connected with the sucker 31, and a second side of the resilient pulling piece 32 extends out of the body 10. The resilient pulling piece 32 is used to insert the user's finger to pull and rotate an opening 33 (as illustrated in FIG. 2). The user inserts fingers into the opening 33 and pulls the resilient pulling piece 32, thereafter a lower end of the resilient pulling piece 32 is rotated outwardly so that an upper end of the resilient pulling piece 32 rotates into the body 10 and pushes the sucker 31 to move downwardly, thereafter a gap 34 forms between the sucker 31 and a bottom surface of the body 10 as shown in FIG. 3. In the meantime, an object placed on the bluetooth swivel bracket 100 presses an upper end of the resilient pulling piece 32 (as illustrated in FIG. 2), and the sucker 31 abuts against the bottom surface of the body 10 so that the gap between the sucker 31 and the bottom surface of the body 10 becomes smaller, hence the sucker 31 adheres the object so as to fix the bluetooth swivel bracket 100 securely. As desiring to remove the object from the bluetooth swivel bracket 100, the user inserts the fingers into the opening 33 and pulls the resilient pulling piece 32 outwardly as illustrated in FIG. 3, and the body 10 is held upwardly so that the sucker 31 removes from the object, thereby removing the object from the bluetooth swivel bracket 100.

Accordingly, the bluetooth swivel bracket 100 is positioned on the object by means of the sucker 31.

Preferably, the body 10 is bent so that when the handheld electronic device rotates, it does not collide the body 10, thus extending rotating angle and rotating position of the bluetooth swivel bracket relative to the handheld electronic device.

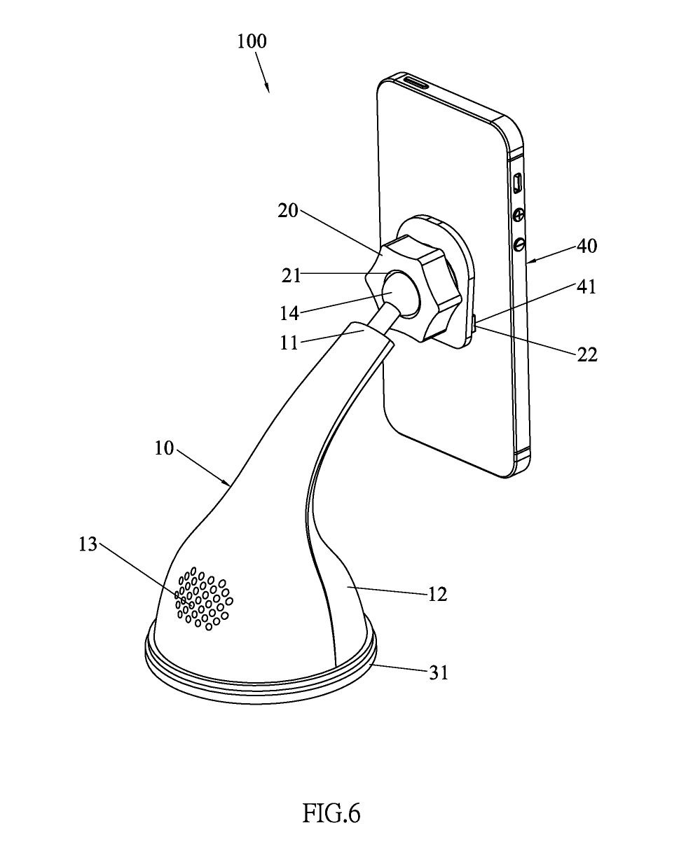

With reference to FIGS. 6 to 9, the upper side 11 of the body 10 is spherical and has a rotary ball 14 mounted thereon, and the universal rotating head 20 includes a spherical cavity 21 defined therein so as to receive the rotary ball 14, such that the handheld electronic device is universally rotated relative to the bluetooth swivel bracket 100.

Preferably, the universal rotating head 20 also includes at least one retainer 22 extending outwardly therefrom, and the handheld electronic device includes at least one locking slot defined on a back surface thereof so as to engage with and disengage from the at least one retainer 22.

It is preferable that the bluetooth swivel bracket 100 further includes a protective case 40 for retaining with the handheld electronic device, and the protective case 40 has the at least one locking slot 41 formed thereon, such that the handheld electronic device is locked on the protective case 40.

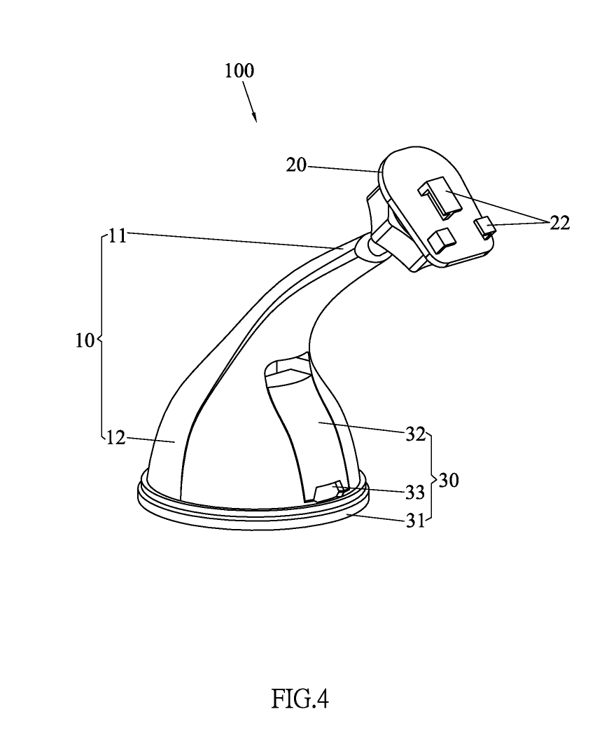

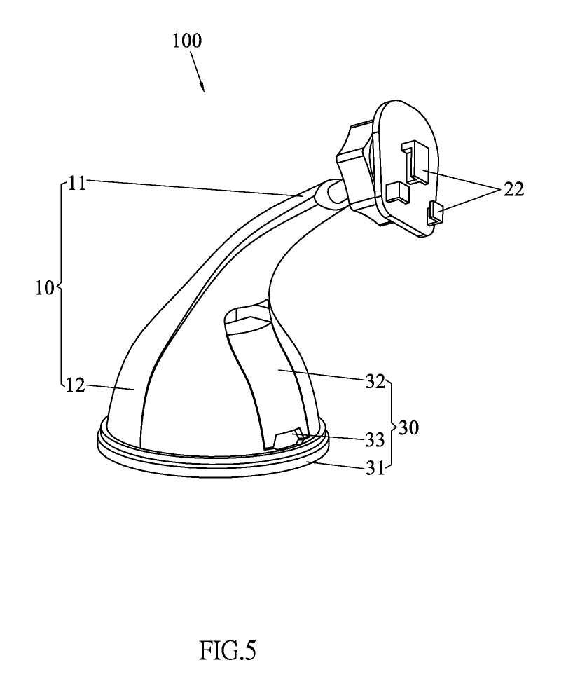

As shown in FIG. 4, the universal rotating head 20 is rotated upwardly relative to the bluetooth swivel bracket 100. As illustrated in FIG. 5, the universal rotating head 20 is rotated to an angle along the bluetooth swivel bracket 100. Thereby, the handheld electronic device is universally rotated to a desired position and a desired position angle by using the bluetooth swivel bracket 100.

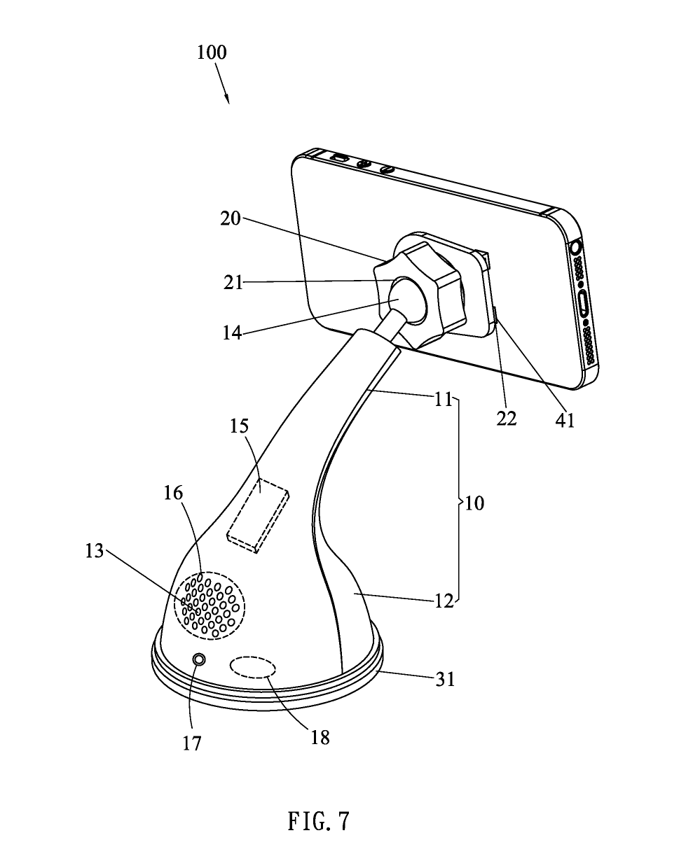

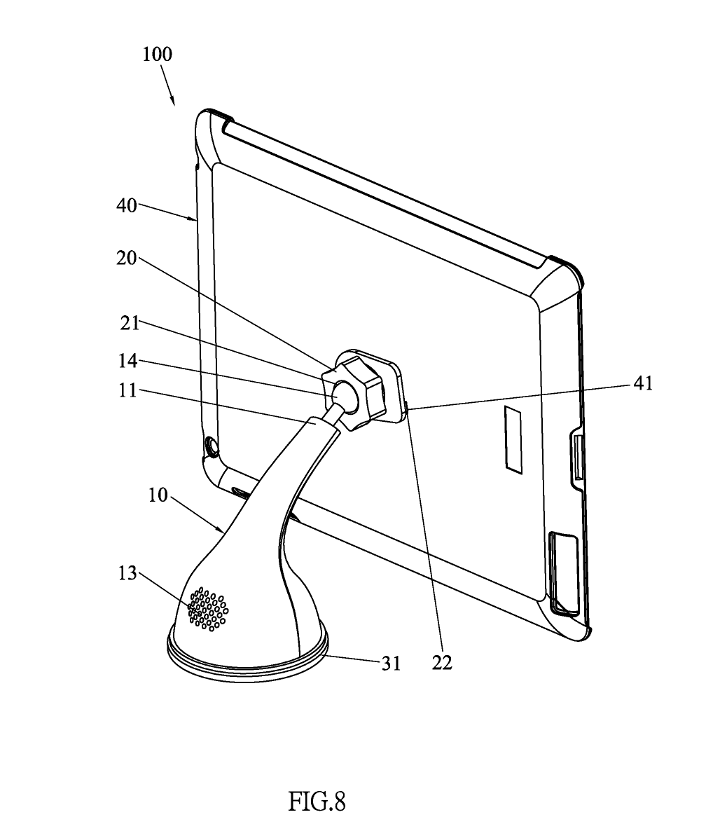

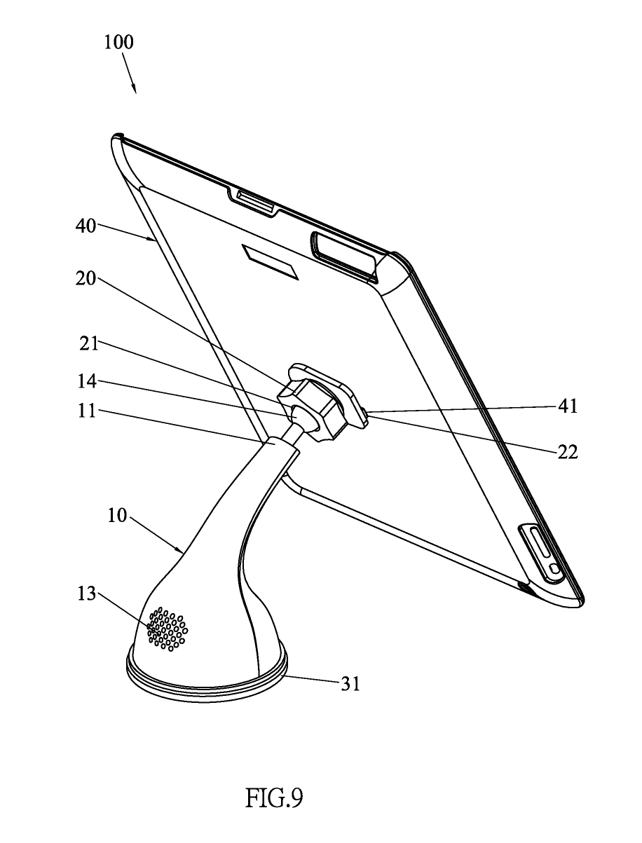

As shown in FIGS. 6 and 7, the protective case 40 is used for fixing a mobile phone. As illustrated in FIGS. 8 and 9, the protective case 40 is applied to position a tablet computer. Furthermore, as shown in FIGS. 6 to 9, a position of the protective case 40 is changed, i.e., the bluetooth swivel bracket 100 is served to rotate the protective case 40 universally. The handheld electronic device is any one of a mobile phone, a PDA, a handheld game console, the tablet computer and a navigation system.

Thereby, the bluetooth swivel bracket of the present invention has the following advantages:

1. The bluetooth swivel bracket 100 can change the handheld electronic device to any desired position and angle randomly, thus enhancing use comfort and convenience.

2. The bluetooth swivel bracket 100 comprises the bluetooth mechanism, and the bluetooth mechanism has the speaker 16 so as to play the audio information of the handheld electronic device directly, such that the user can adjust sound volume and tone in different conditions. In addition, a power consumption of the handheld electronic device for playing the audio information is saved, and a standby time of the handheld electronic device is prolonged.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A bluetooth swivel bracket being used to hold a handheld electronic devices and to play audio information of the handheld electronic device and comprising: a body, a universal rotating head, and a bluetooth mechanism disposed in the body, wherein
an upper side of the body is rotatably connected with the universal rotating head, the bluetooth mechanism includes a bluetooth module for receiving the audio information of the handheld electronic device, a speaker, and a power supply component for supplying power;
the power supply component and the speaker are electrically connected with the bluetooth module, and the speaker is provided to play the audio information of the handheld electronic device.

2. The bluetooth swivel bracket as claimed in claim 1, wherein the bluetooth mechanism includes a receiver electrically coupled with the bluetooth module and applied to receive outside sounds and to transmit the outside sounds into the handheld electronic device.

3. The heat dissipation case as claimed in claim 1, wherein the bluetooth mechanism also includes at least one volume control key electrically connected with the speaker.

4. The bluetooth swivel bracket as claimed in claim 1 further comprising a sucking mechanism, and the sucking mechanism includes a sucker mounted on a lower side of the body.

5. The bluetooth swivel bracket as claimed in claim 4, wherein the sucking mechanism also includes a resilient pulling piece rotatably joined with the body, a first side of the resilient pulling piece inserts into the body and is connected with the sucker, and a second side of the resilient pulling piece extends out of the body.

6. The bluetooth swivel bracket as claimed in claim 1, wherein the body is bent.

7. The bluetooth swivel bracket as claimed in claim 1, wherein the body includes a plurality of sound guiding holes defined thereon and corresponding to the speaker.

8. The bluetooth swivel bracket as claimed in claim 1, wherein the upper side of the body is spherical and has a rotary ball mounted thereon, and the universal rotating head includes a spherical cavity defined therein so as to receive the rotary ball.

9. The bluetooth swivel bracket as claimed in claim 1, wherein the universal rotating head also includes at least one retainer extending outwardly therefrom, and the handheld electronic device includes at least one locking slot defined on a back surface thereof so as to engage with and disengage from the at least one retainer.

10. The bluetooth swivel bracket as claimed in claim 9, wherein the bluetooth swivel bracket further includes a protective case for retaining with the handheld electronic device.
